(19) United States
(12) Patent Application Publication
(10) Pub. No.: US 2025/0042027 A1
(43) Pub. Date: Feb. 6, 2025

(54) ROBOT, DEVICE FOR MANAGING OPERATION OF ROBOT, SYSTEM INCLUDING THE SAME, AND METHOD FOR MANAGING OPERATION OF ROBOT

(71) Applicants: Hyundai Motor Company, Seoul (KR); Kia Corporation, Seoul (KR)

(72) Inventors: Jung Min Ryu, Hwaseong-si (KR); Yun Jae Kim, Seongnam-si (KR); Jin Woo Kim, Seoul (KR)

(21) Appl. No.: 18/508,529

(22) Filed: Nov. 14, 2023

(30) Foreign Application Priority Data
Aug. 3, 2023 (KR) 10-2023-0101657

(51) Int. Cl. B25J 9/16

(52) U.S. Cl. CPC B25J 9/1664; B25J 9/1674

(57) ABSTRACT

An embodiment device for managing an operation of a robot includes a memory configured to store computer-executable instructions, a communication device configured to be in communication with a control server, and at least one processor configured to access the memory and execute the instructions, to cause the at least one processor to set a driving time of at least one module included in a target operation among a plurality of operations classified based on driving of at least one module included in the robot, set a driving option of the at least one module whose driving time is set, verify the target operation via simulation of a graphic object corresponding to the robot, and transmit the verified target operation to the control server via the communication device such that the verified target operation is applied to the robot.

### CROSS-REFERENCE TO RELATED APPLICATIONS

This application claims the benefit of Korean Patent Application No. 10-2023-0101657, filed on Aug. 3, 2023, which application is hereby incorporated herein by reference.

### TECHNICAL FIELD

The present disclosure relates to a robot, a device for managing an operation of the robot, a system including the same, and a method for managing the operation of the robot.

### BACKGROUND

A robot technology is used in various industrial fields. Control of various functions such as a service function, a patrol function, and a delivery function is essential for robots used in each industrial field. In the past, a corresponding function or operation was defined in units of source code, and the robot was controlled to execute the corresponding function or operation in response to a command.

A process of defining the function or the operation of the robot includes processes of writing the source code of a user, and building, simulating, and testing with an actual robot. Such processes may be inefficient processes in terms of distributing and applying the newly defined functions or operation to the robot in actual operation. In addition, such processes had a limit for a third party to infer the operation of the robot via the user's source code, and it was difficult to test the robot by building a separate simulation environment or to apply requirements for changes to the robot.

In addition, when a test for an expensive robot is required, when there is no separate test robot, or when at least one user performs the test on one test robot, the user may transmit an incorrect operation command to the test robot, causing a failure of the robot, or the cooperating users may transmit an execution command to the robot at the same time, causing an error in the robot. For example, the user may generate the error in the robot by executing a command with an angle equal to or greater than a physically available angle of a robot arm or a command with a velocity equal to or higher than an available velocity.

To solve such a problem, it is necessary to develop a technology related to a robot, a device for managing an operation of the robot, a system including the same, and a method for managing the operation of the robot that provide information related to the operation of the robot to a user via a graphic object.

### SUMMARY

The present disclosure relates to a robot, a device for managing an operation of the robot, a system including the same, and a method for managing the operation of the robot. Particular embodiments relate to a technology for providing information related to an operation of a robot to a user via a graphic object.

Embodiments of the present disclosure can solve problems occurring in the prior art while advantages achieved by the prior art are maintained intact.

An embodiment of the present disclosure provides a robot, a device for managing an operation of the robot, a system including the same, and a method for managing the operation of the robot that may generate and modify a target operation related to the operation of the robot to control the operation of the robot based on units of the operation for each module mounted on the robot instead of controlling the operation of the robot in units of source code, and provide convenience and efficiency to a developer or a user in the process of controlling the operation of the robot.

Another embodiment of the present disclosure provides a robot, a device for managing an operation of the robot, a system including the same, and a method for managing the operation of the robot that may verify a target operation for a graphic object corresponding to the robot to minimize a need for a test robot and reduce a development cost of the robot, guarantee safety of the test robot against concurrent execution of a plurality of developers or users, and provide usability to the developers or the users.

Another embodiment of the present disclosure provides a robot, a device for managing an operation of the robot, a system including the same, and a method for managing the operation of the robot that may perform safety validation on a module mounted on the robot to guarantee stability of a test robot as well as rapidity of reflecting a modification request of a user to the robot in real time via association of an engine that interprets operation data and an operation rather than code reflected to the robot after building of source code.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a device for managing an operation of a robot includes a memory that stores computer-executable instructions and at least one processor that accesses the memory and executes the instructions, and the at least one processor sets a driving time of at least one module included in a target operation among a plurality of operations classified based on driving of at least one module included in the robot, sets a driving option of the at least one module whose driving time is set, verifies the target operation via simulation of a graphic object corresponding to the robot, and transmits the verified target operation to the control server via a communication device such that the verified target operation is applied to the robot.

In one implementation, the at least one processor may set, based on a case where an operation different from the target operation is added to an operation list containing the target operation, a driving time of at least one module included in the different operation, and set a driving option of the at least one module included in the different operation.

In one implementation, the at least one processor may provide, based on a case where there are a plurality of execution commands for applying an operation different from the target operation to the robot, information on an operation corresponding to each of the plurality of execution commands.

In one implementation, the at least one processor may obtain raw data of the target operation based on a first input of a user and reflect, based on a case where at least one of a first element related to the driving time or a second element related to the driving option contained in the raw data or any combination is modified, the modification to the target operation.

In one implementation, the at least one processor may verify whether raw data of the target operation meets a data standard based on a second input of a user, transmit the target operation to the control server via the communication device based on a case where the raw data meets the data standard, and provide a predetermined alarm to the user based on a case where the raw data does not meet the data standard.

In one implementation, the at least one processor may receive, based on a third input of a user, an alternative operation corresponding to the target operation and stored at a time point closest to a time point when the third input is received among operations stored in the control server from the control server via the communication device, and the at least one processor may replace the target operation with the alternative operation.

In one implementation, the at least one processor may transmit an execution command to the control server such that the target operation transmitted to the control server is applied to the robot based on a fourth input of a user.

According to another embodiment of the present disclosure, a system for managing an operation of a robot includes a robot operation management device, a control server, and the robot that receives a command from the control server. The robot operation management device sets a driving time of at least one module included in a target operation among a plurality of operations classified based on driving of at least one module included in the robot, sets a driving option of the at least one module whose driving time is set, verifies the target operation via simulation of a graphic object corresponding to the robot, and transmits the verified target operation to the control server such that the verified target operation is applied to the robot, and the control server transmits an execution command to the robot based on the verified target operation received from the robot operation management device.

In one implementation, the control server may perform safety validation for the at least one module mounted on the robot based on the reception of the verified target operation from the robot operation management device, the control server may process the execution command by referring to a waiting queue based on reception of the execution command for applying the target operation to the robot, and the robot may apply the target operation to the at least one module in response to the processed execution command.

In one implementation, the safety validation may include, based on a case where the received target operation is applied to the at least one module included in the robot, at least one of validation of a position of the module, validation of a velocity of the module, validation of a torque of the module, or validation of an acceleration of the module, or any combination.

In one implementation, the control server may determine whether the received target operation uses a drive system including a servo motor related to the driving of the at least one module, obtain a threshold value related to the safety validation based on a case where the received target operation uses the drive system, and perform the safety validation by comparing the obtained threshold value with the driving option included in the received target operation.

In one implementation, the control server may transmit an alarm provision command to the robot operation management device such that the robot operation management device provides a predetermined alarm to a user based on a case where at least one of the driving options included in the received target operation is greater than the obtained threshold value.

In one implementation, the control server may store the target operation in storage of the control server based on a case where the safety validation for the at least one module mounted on the robot is passed.

In one implementation, the control server may insert the execution command into the waiting queue based on a case where an operation of a preceding execution command preceding the execution command is being applied to the robot, and the control server may process an execution command inserted first among the execution commands inserted into the waiting queue based on a case where the preceding execution command is ended.

In one implementation, the control server may process the execution command based on a case where the robot is in an execution standby state.

According to another embodiment of the present disclosure, a robot obtains information on at least one module included in a target operation related to an execution command received from a control server and performs an inspection on whether the at least one module is a module mounted on the robot.

In one implementation, the robot may set a second time point subsequent to a first time point for obtaining the information on the at least one module included in the target operation based on a case where the at least one module included in the target operation is the module mounted on the robot, transmit a standby command for setting the at least one module to be in a standby mode from the first time point to the second time point to the at least one module, and apply the target operation to the at least one module from the second time point.

In one implementation, the robot may set a third time point being different from the first time point and the second time point and indicating an end time point of the target operation, obtain a state of the robot applying the target operation based on a predetermined clock from the second time point, and end the target operation applied to the at least one module based on at least one of whether the state of the robot is an end state or a time point for obtaining the state of the robot is subsequent to the third time point or any combination.

According to another embodiment of the present disclosure, a method for managing an operation of a robot includes setting, by a robot operation management device, a driving time of at least one module included in a target operation among a plurality of operations classified based on driving of at least one module included in the robot, setting, by the robot operation management device, a driving option of the at least one module whose driving time is set, verifying, by the robot operation management device, the target operation via simulation of a graphic object corresponding to the robot, transmitting, by the robot operation management device, the verified target operation to a control server such that the verified target operation is applied to the robot, and transmitting, by the control server, an execution command to the robot based on the verified target operation received from the robot operation management device.

In one implementation, the method may further include performing, by the control server, safety validation for the at least one module mounted on the robot based on the reception of the verified target operation from the robot operation management device, processing, by the control server, the execution command by referring to a waiting queue based on reception of the execution command for applying the target operation to the robot, and applying, by the robot, the target operation to the at least one module in response to the processed execution command.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a diagram illustrating a robot operation management device according to an embodiment of the present disclosure;

FIG. 2 is a flowchart for illustrating a robot operation management method according to an embodiment of the present disclosure;

FIGS. 3 and 4 are diagrams illustrating a robot operation management system according to an embodiment of the present disclosure;

FIG. 5 is a diagram showing a screen provided to a user in a robot operation management device according to an embodiment of the present disclosure;

FIG. 6 is a diagram illustrating an example of raw data of a target operation in a robot operation management device according to an embodiment of the present disclosure;

FIG. 7 is a flowchart illustrating a method for a control server to perform safety validation for a module of a robot in a robot operation management system according to an embodiment of the present disclosure;

FIG. 8 is a flowchart illustrating a method for a control server to process an execution command in a robot operation management system according to an embodiment of the present disclosure;

FIG. 9 is a diagram illustrating a method for a control server to insert an execution command into a waiting queue in a robot operation management system according to an embodiment of the present disclosure;

FIG. 10 is a flowchart illustrating a method for a robot to apply a target operation to a module in a robot operation management system according to an embodiment of the present disclosure;

FIG. 11 is a diagram illustrating operations stored in storage of a control server in a robot operation management system according to an embodiment of the present disclosure; and

FIG. 12 is a diagram illustrating a computing system related to a robot, a robot operation management device, a system including the same, and a robot operation management method according to an embodiment of the present disclosure.

With regard to the description of the drawings, the same or similar reference numerals may be used for the same or similar components.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiments of the present disclosure, a detailed description of the related known configuration or function will be omitted when it is determined that it interferes with the understanding of the embodiments of the present disclosure. In particular, various embodiments of the present disclosure are described with reference to the accompanying drawings. However, this is not intended to limit the technology described herein to the specific embodiments, and should be understood to include various modifications, equivalents, and/or alternatives of the embodiments of the present disclosure. In connection with the description of the drawings, like reference numerals may be used for like components.

In describing the components of the embodiments according to the present disclosure, terms such as first, second, A, B, (a), (b), and the like may be used. These terms are merely intended to distinguish the components from other components, and the terms do not limit the nature, order, or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. For example, expressions such as “first”, “second”, and the like used herein which may modify various components, regardless of an order and/or importance, are used to only distinguish one component from another and do not limit the corresponding components. For example, a first user device and a second user device may represent different user devices regardless of the order or the importance. For example, without departing from the scope of rights described herein, a first component may be referred to as a second component, and similarly, the second component may also be referred to as the first component.

Herein, an expression such as “has”, “may have”, “include”, or “may include” refers to presence of a corresponding feature (e.g., a numerical value, a function, an operation, or a component such as a module) and does not exclude the presence of additional features.

When one component (e.g., the first component) is referred to as being “(operatively or communicatively) coupled with/to” another component (e.g., the second component), it should be understood that the one component may be directly coupled to said another component or may be connected to said another component via still another component (e.g., a third component). On the other hand, when one component (e.g., the first component) is referred to as being “directly coupled with/to” another component (e.g., the second component), it may be understood that still another component (e.g., the third component) does not exist between the one component and said another component.

The expression “configured to ˜” used herein may be, for example, used interchangeably with “suitable for ˜”, “having the capacity to ˜”, “designed to ˜”, “adapted to ˜”, “made to ˜”, or “capable of ˜” depending on circumstances.

The term “configured to ˜” may not necessarily mean only “specifically designed to ˜” in terms of hardware. Instead, in some circumstances, the expression “device configured to ˜” may mean that the device is “capable of ˜” in conjunction with other devices or components. For example, the phrase “processor configured to perform A, B, and C” may mean a dedicated processor (e.g., an embedded processor) to perform the corresponding operations, or it may mean a generic-purpose processor (e.g., a CPU or an application processor) capable of performing the corresponding operations by executing one or more software programs stored in a memory device. Terms used herein are only used to describe a specific embodiment and may not be intended to limit the scope of another embodiment. A singular expression may include a plural expression unless the context clearly dictates otherwise. Terms used herein, including technical or scientific terms, may have the same meaning as commonly understood by a person of ordinary skill in the technical field described herein. Among the terms used herein, terms defined in a general dictionary may be interpreted as having the same or similar meaning as the meaning in the context of the related art and may not be interpreted as having the ideal or excessively formal meaning unless explicitly defined herein. In some cases, even terms defined herein are not able to be interpreted to exclude the embodiments of the present disclosure.

Herein, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) at least one A, (2) at least one B, or (3) at least one A and at least one B. In addition, in describing the components of the embodiment of the present disclosure, each of phrases such as “A or B”, “at least one of A and B”, “at least one of A or B”, “A, B, or C”, “at least one of A, B, and C”, “at least one of A, B, or C”, and “at least one of A, B, or C, or any combination thereof” may include any one of the items listed together in the corresponding phrase or all possible combinations thereof. In particular, the phrase such as “at least one of A, B, or C, or any combination thereof” may include A or B or C or combinations thereof such as AB or ABC.

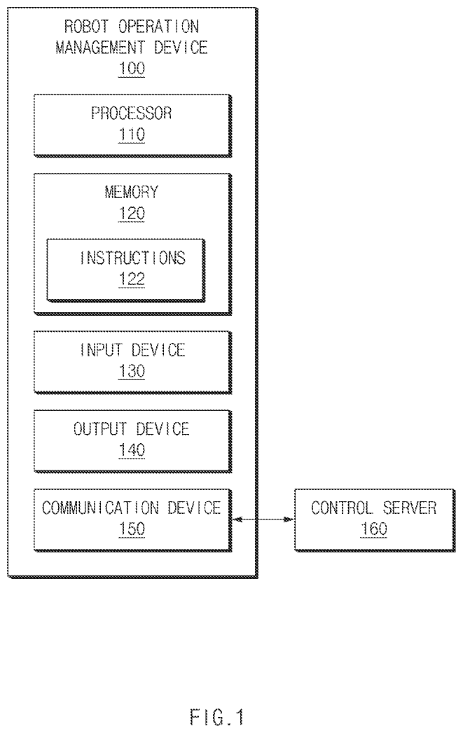

Hereinafter, with reference to FIGS. 1 to 12, embodiments of the present disclosure will be described in detail.

FIG. 1 is a diagram illustrating a robot operation management device according to an embodiment of the present disclosure.

A robot operation management device 100 according to an embodiment may include a processor 110, a memory 120 including instructions 122, an input device 130, an output device 140, and a communication device 150.

The robot operation management device 100 may represent a device that generates or modifies an operation of a robot based on an input of a user or a timeline based on a predetermined method without direct modification of source code. For example, the robot operation management device 100 may set a target operation among a plurality of operations classified based on driving of at least one module included in the robot. The at least one module included in the robot may include at least one of a neck module, a moving module, a right arm (arm_right) module, a left arm (arm_left) module, a top light (led_top) module, a bottom light (led_bottom) module, a sound module, a text to speech (tts) module, a top screen (screen_top), a middle screen (screen_mid), or a bottom screen (screen_bottom) of the robot, or any combination thereof. Herein, for convenience of description, the module included in the robot is mainly described as an example of the above module, but the present disclosure is not limited thereto. For example, the at least one module included in the robot may include various modules for driving the robot.

The target operation may include a driving time and a driving option. For example, the driving time may indicate a driving time of the at least one module included in the robot. The driving option may indicate a driving method or a behavior of the at least one module included in the robot. Taking the right arm module mounted on the robot as an example, a driving option of the right arm module may include at least one of a control direction option (e.g., up or down), a velocity option (e.g., 0.1 m/s), an angle option (e.g., 30 degrees), a start time point (startAt) option, a duration option, or any combination thereof.

The robot operation management device 100 may set a driving time of at least one module included in the target operation and set a driving option of the at least one module for which the driving time is set. However, the method for setting the driving option of the at least one module is not limited thereto. For example, the robot operation management device 100 may simultaneously set the driving time and the driving option of the at least one module included in the target operation. Alternatively, the robot operation management device 100 may set the driving option first and then set the driving time.

The robot operation management device 100 may verify the target operation via simulation of a graphic object corresponding to the robot. For example, the robot operation management device 100 may provide the graphic object corresponding to the robot to the user via the output device 140. The user may transmit a simulation request for the provided graphic object to the robot operation management device 100 via the input device 130. The robot operation management device 100 may perform the simulation of the graphic object corresponding to the robot in response to the user's simulation request. The simulation of the graphic object may include a process of providing results related to the target operation when the target operation is applied to the robot. For example, the simulation of the graphic object may include simulation of at least one of an expected motion of the robot, a color of the at least one module mounted on the robot, or a sound of the at least one module mounted on the robot, or any combination thereof. The robot operation management device 100 may verify the target operation via the simulation of the graphic object (i.e., a virtual robot) corresponding to the robot without simulating the target operation for a separate test robot (i.e., an actual robot).

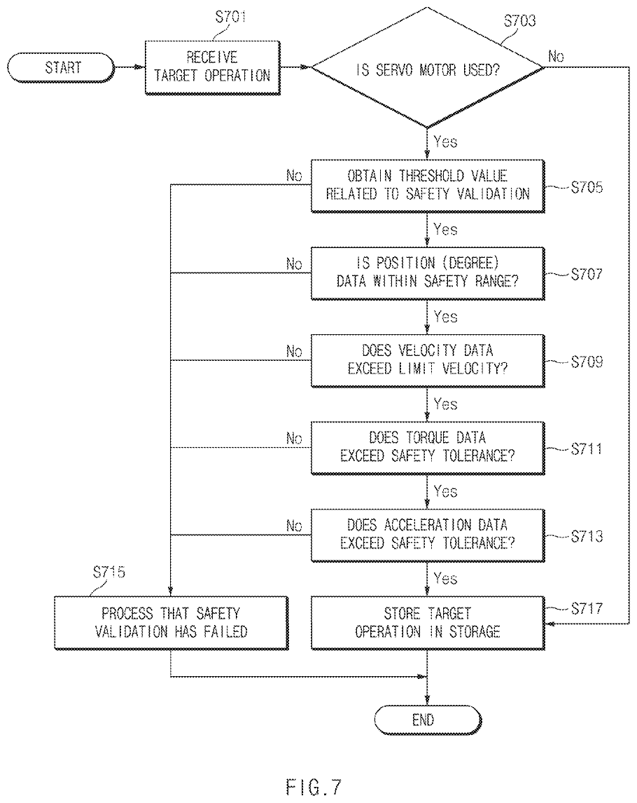

The robot operation management device 100 may transmit the verified target operation to a control server 160 via the communication device 150 such that the verified target operation is applied to the robot. The process of applying the target operation to the robot may include a process in which the robot performs the target operation as the driving time and the driving option included in the target operation generated by the robot operation management device 100 are applied to the robot. A detailed description of the application of the target operation to the robot will be made later with reference to FIGS. 7 to 10 below.

The processor 110 may execute software and control at least one other component (e.g., a hardware or software component) connected to the processor 110. In addition, the processor 110 may perform various data processing or calculations. For example, the processor 110 may store at least one of the driving time, the driving option, the target operation, or raw data, or any combination thereof in the memory 120. For reference, the processor 110 may perform all operations performed by the robot operation management device 100. Therefore, herein, for convenience of description, the operation performed by the robot operation management device 100 is mainly described as the operation performed by the processor 110.

In addition, herein, for convenience of description, the processor 110 is mainly described as being a single processor, but it is not limited thereto. For example, the robot operation management device 100 may include at least one processor. Each of the at least one processor may perform all operations related to the operation of the robot operation management device 100 that performs robot operation management.

The memory 120 may temporarily and/or permanently store various data and/or information required to perform the robot operation management. For example, the memory 120 may store at least one of the driving time, the driving option, the target operation, or the raw data, or any combination thereof.

The input device 130 may indicate a component for obtaining user data. For example, the input device 130 may obtain, as the user data, content of the generation or the modification of the target operation applied to the robot. However, embodiments of the present disclosure may not be limited to the above-described embodiment, and the input device 130 may obtain data in various formats as the user data. For example, the input device 130 may obtain data directly input by the user as the user data. The input device 130 may include at least one of a camera, a microphone, or a touch panel, or any combination thereof to obtain various external inputs.

The output device 140 may output graphic objects for the modification content of the target operation applied to the robot. In this regard, an output that is output via the output device 140 may be in various forms. For example, the output that is output via the output device 140 may include at least one of an output of the graphic object or an output of a plurality of objects for modifying the target operation or any combination thereof. The display may be a component for outputting results of the user data obtained via the input device 130 as an image. The output device 140 may include a display as an example. The display may output the graphic object for expressing the content of modification of the target operation applied to the robot. That is, when it is desired to output an operation of the robot in response to the user data obtained via the input device 130, the operation of the robot for the user data may be output via the graphic object displayed on the display. In one example, the display for providing various images may be implemented as various types of display panels. For example, the display panel may be implemented with various display technologies such as a liquid crystal display (LCD), an organic light emitting diode (OLED), an active-matrix organic light-emitting diode (AM-OLED), a liquid crystal on silicon (LcoS), or a digital light processing (DLP).

The communication device 150 may support communication establishment between the robot operation management device 100 and the control server 160. For example, the communication device 150 may include one or more components enabling the communication between the robot operation management device 100 and the control server 160. For example, the communication device 150 may include a short range wireless communication unit, a microphone, and the like. In this regard, a short-range communication technology may include wireless LAN (Wi-Fi), Bluetooth, ZigBee, Wi-Fi direct (WFD), ultra-wideband (UWB), infrared data association (IrDA), Bluetooth low energy (BLE), near field communication (NFC), and the like, but may not be limited thereto.

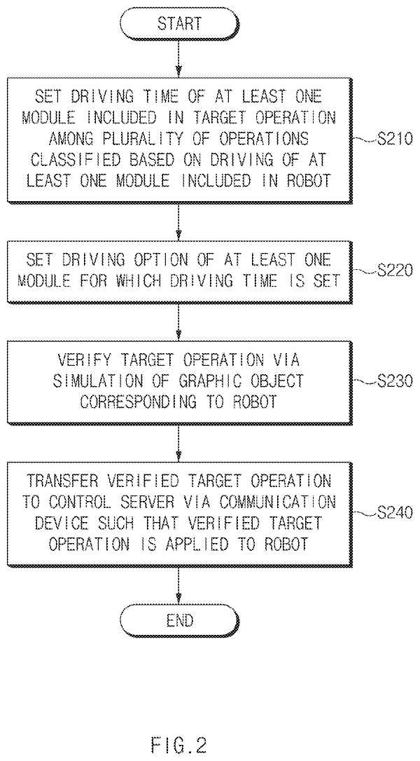

FIG. 2 is a flowchart for illustrating a robot operation management method according to an embodiment of the present disclosure.

In S210, a robot operation management device (e.g., the robot operation management device 100 in FIG. 1) may set a driving time of at least one module included in a target operation among a plurality of operations classified based on driving of at least one module included in a robot.

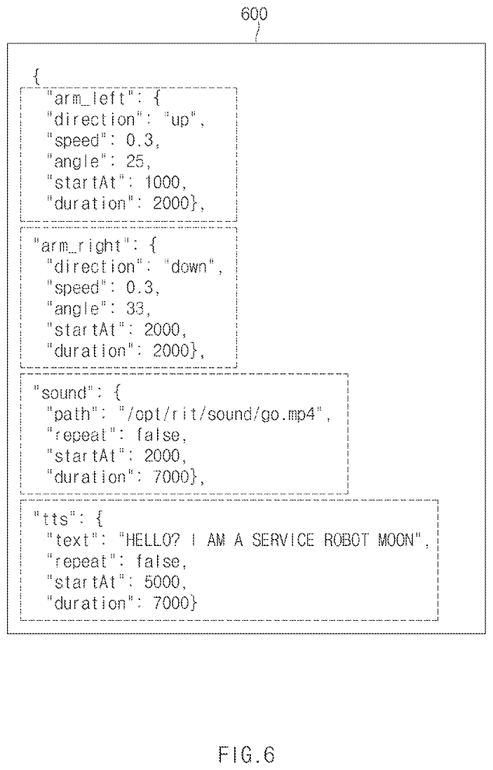

In S220, the robot operation management device may set a driving option of the at least one module for which the driving time is set. For example, the robot operation management device may generate or modify an operation of the robot without directly modifying source code related to the operation of the robot by setting the driving time and the driving option based on an input of a user. For reference, the robot operation management device may generate or modify the source code (e.g., raw data) related to the operation of the robot by generating or modifying the operation of the robot. A detailed description of the raw data will be made later with reference to FIG. 6 below.

In S230, the robot operation management device may verify the target operation via simulation of a graphic object corresponding to the robot. For example, in relation to the verification of the target operation, the verification of the target operation may include a first verification and a second verification. The first verification may be a verification that the robot operation management device applies the target operation to the graphic object corresponding to the robot. The robot operation management device may provide the user with a situation in which the target operation is applied to the robot via the graphic object by performing the first verification. Alternatively, the second verification may be a verification by the robot operation management device on whether the raw data related to the operation of the robot meets a data standard. The robot operation management device may provide information on suitability of the raw data to the user before the target operation is applied to the robot by performing the second verification. That is, the user does not directly generate or modify the source code (e.g., the raw data) related to the target operation but generates or modifies the operation of the robot based on a timeline via an input to the robot operation management device. Therefore, the robot operation management device performs verification (i.e., the second verification) on whether generation or modification of the target operation based on the user's input or a predetermined method is appropriately made even for the raw data.

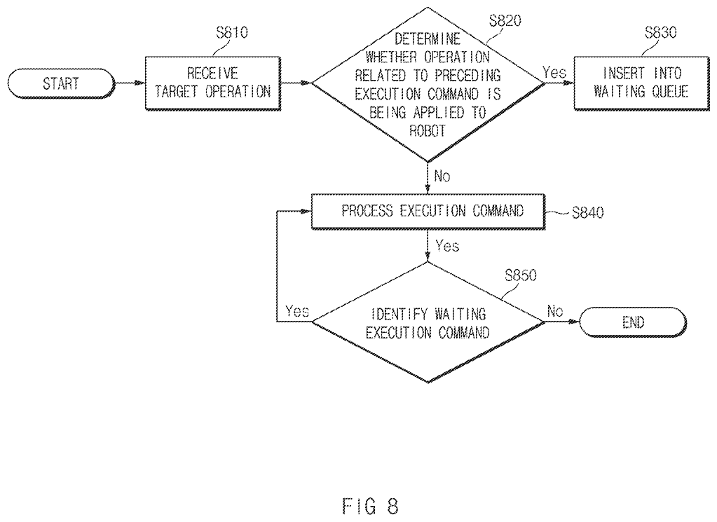

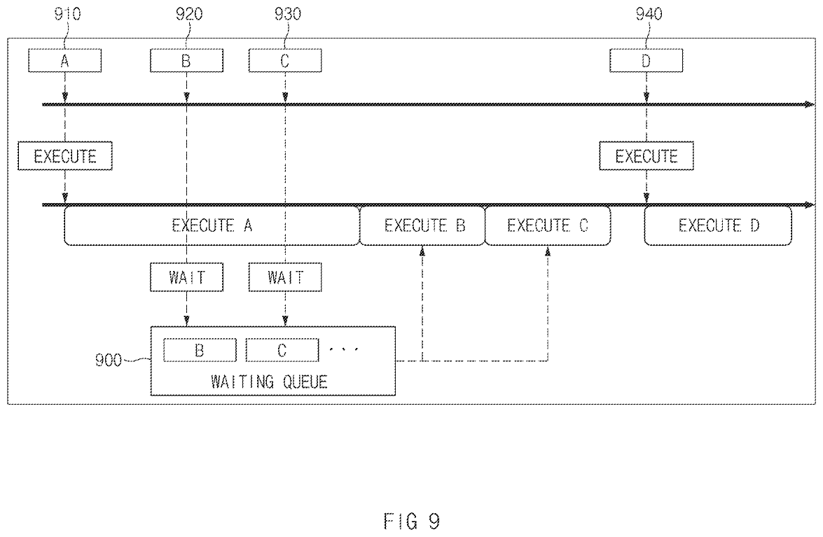

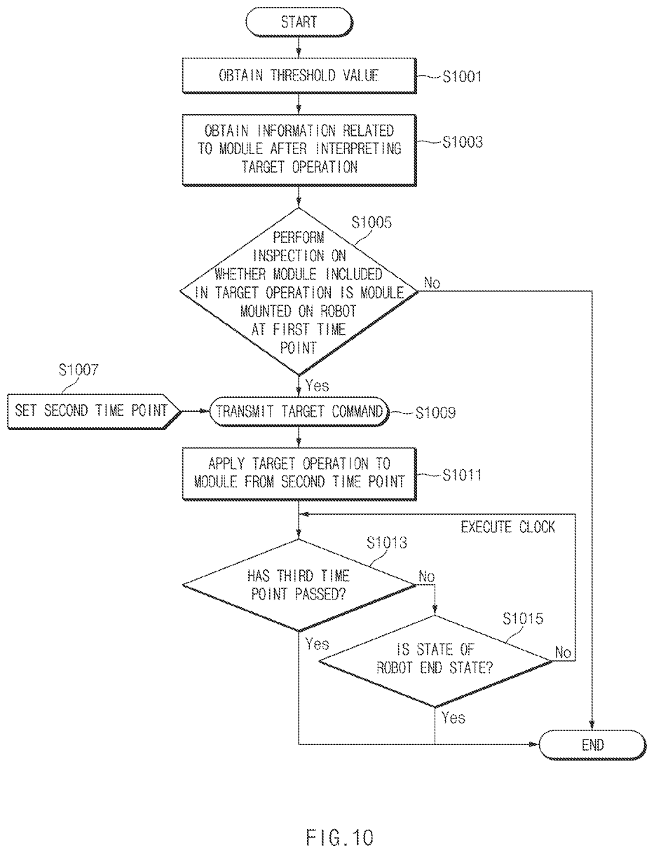

In S240, the robot operation management device may transfer the verified target operation to a control server (e.g., the control server 160 in FIG. 1) such that the verified target operation is applied to the robot. Thereafter, the control server may transmit an execution command to the robot based on the verified target operation received from the robot operation management device. Based on the reception of the verified target operation from the robot operation management device, the control server may perform safety validation on the at least one module mounted on the robot. A detailed method for the control server to perform the safety validation will be described later with reference to FIG. 7 below. Based on the reception of the execution command for applying the target operation to the robot, the control server may process the execution command by referring to a waiting queue. A detailed method of processing the execution command by the control server will be described later with reference to FIGS. 8 and 9 below. The robot may apply the target operation to the at least one module in response to the processed execution command. A detailed method for the robot to respond to the processed execution command will be described later with reference to FIG. 10 below.

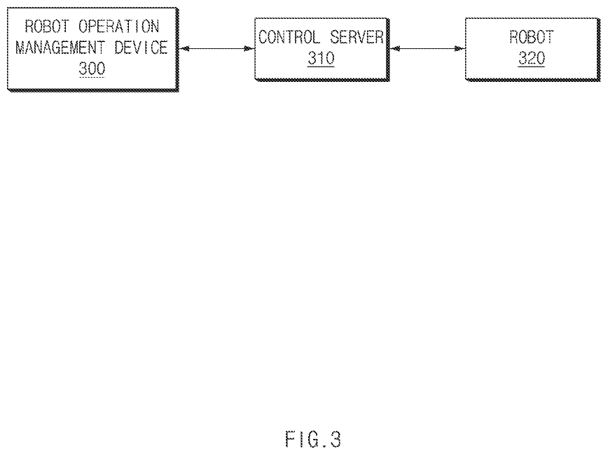

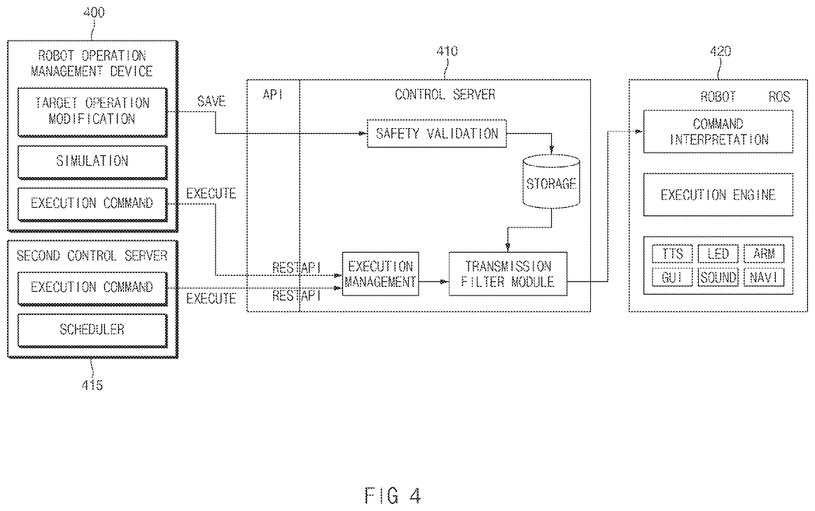

FIGS. 3 and 4 are diagrams illustrating a robot operation management system according to an embodiment of the present disclosure.

Referring to FIG. 3, a system according to an embodiment of the present disclosure may include a robot operation management device 300, a control server 310, and a robot 320.

The robot operation management device 300 may represent the same robot operation management device as the robot operation management device described above with reference to FIG. 1. In other words, the robot operation management device 300 may set a driving time of at least one module included in a target operation among a plurality of operations classified based on driving of at least one module included in a robot, set a driving option of the at least one module for which the driving time is set, verify the target operation via simulation of a graphic object corresponding to the robot, and transmit the verified target operation to the control server 310 such that the verified target operation is applied to the robot 320. The robot operation management device 300 may be in communication with the control server 310. The robot operation management device 300 may transmit at least one of the target operation, an alternative operation, an execution command, or a notification providing command, or any combination thereof to the control server 310. However, in FIGS. 3 and 4, for convenience of description, the robot operation management device 300 is shown to be in communication with the control server 310, but the present disclosure is not limited thereto. For example, the robot operation management device 300 may skip the control server 310 and transmit at least one of the target operation, the alternative operation, the execution command, or the notification providing command, or any combination thereof directly to the robot 320.

The control server 310 may transmit the execution command to the robot 320 based on the verified target operation received from the robot operation management device 300. For example, the control server 310 may perform safety validation on the at least one module mounted on the robot 320 based on the reception of the verified target operation from the robot operation management device 300. In addition, the control server 310 may process the execution command by referring to a waiting queue based on the reception of the execution command for applying the target operation to the robot 320. The control server 310 may transmit at least one of the target operation, the execution command, a standby command, or an end command, or any combination thereof to the robot 320.

The robot 320 may apply the target operation to the at least one module in response to the execution command processed by the control server 310. For example, the robot 320 may apply the target operation to the at least one module in response to the finally processed execution command via the reference of the safety validation of the module related to the target operation and the waiting queue including execution commands related to the application of the target operation, based on the control server 310 receiving the verified target operation received from the robot operation management device 300.

Referring to FIG. 4, a system according to an embodiment of the present disclosure may include a robot operation management device 400, a control server 410, a second control server 415, and a robot 420.

The robot operation management device 400 may generate or modify a target operation, perform simulation on a graphic object corresponding to the robot to verify the target operation, and generate an execution command. For example, the robot operation management device may transmit the generated or modified target operation to the control server 410 via an application program interface (API) of the control server 410. In addition, the robot operation management device 400 may transmit the execution command for applying the target operation to the robot 420 to the control server 410 via a representational state transfer (REST) application program interface of the control server 410.

The second control server 415 may represent a control server that automatically performs scheduling such that the execution command is transmitted or processed. For example, the second control server 415 may generate an execution command the same as the execution command transmitted to the control server 410 by the robot operation management device 400 and transmit the generated execution command to the control server 410. Like the robot operation management device 400, the second control server 415 may transmit the execution command for applying the target operation to the robot 420 to the control server 410 via the REST application program interface of the control server 410. In this regard, the second control server 415, as a control server different from the control server 410, may represent a control server that generates and transmits the execution command and performs the scheduling on the execution command. In summary, via the execution command (i.e., a manual command) by an input of a user received from the robot operation management device 400 or a predetermined method and the execution command (i.e., an automatic command) received via the scheduling received from the second control server 415, the control server 410 may receive the execution command from at least one of the robot operation management device 400 and the second control server 415.

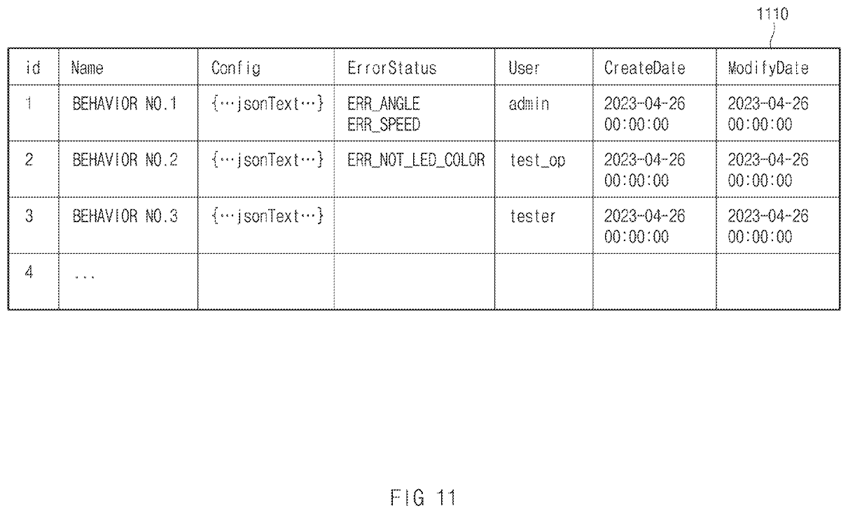

The control server 410 may transmit the execution command to the robot 420 after processing the execution command (e.g., safety validation or the scheduling) based on the target operation received from the robot operation management device 400. For example, the control server 410 may perform the safety validation on at least one module mounted on the robot 420 based on the reception of the target operation. The control server 410 may store the received target operation in storage based on a case where the safety validation for the at least one module mounted on the robot 420 is passed. For reference, an example of the target operation stored in the storage will be described later in detail with reference to FIG. 11 below. The control server 410 may secure safety of data until the target operation is applied to the robot 420 via the safety validation for the at least one module related to the target operation received from the robot operation management device 400.

The control server 410 may process the execution command by referring to a waiting queue based on the reception of the execution command for applying the target operation to the robot 420 from at least one of the robot operation management device 400 and the second control server 415. The control server 410 may prevent a danger of the robot 420 for concurrent execution of multiple users or multiple developers in a preemptive manner via separate management of one or more various commands such as the execution command.

The control server 410 may process the execution command by referring to the waiting queue, and then the control server 410 may transmit the target operation and the execution command related to the target operation to the robot 420 via a transmission filter module. For example, the control server 410 transmits the received execution command when a corresponding ID exists as a result of searching for an ID of the target operation in the storage by the transmission filter module. The control server 410 may transmit the target operation and the execution command related to the target operation that have passed through the transmission filter module to the robot 420 via an open source solution in a form of middleware such as kafka (Apache Kafka). However, a method for the control server 410 to transmit the target operation and the execution command related to the target operation to the robot 420 is not limited thereto. For example, the control server 410 may transmit the target operation and the execution command related to the target operation that have passed through the transmission filter module to the robot 420 via the open source solution in the form of middleware such as general-purpose remote procedure call (gRPC), REST-API, web real-time communication (WebRTC), and message queuing telemetry transport (MQTT).

In response to the reception of the execution command processed by the control server 410, the robot 420 may apply the target operation to the at least one module (e.g., shown as TTS, LED, ARM, GUI, SOUND, and NAVI in FIG. 4) mounted on the robot 420. For example, the robot 420 may obtain results of interpreting the execution command and apply the target operation to the at least one module via an execution engine. The robot 420 interprets the execution command and transmits a command to which the target operation may be applied via a robot operating system (ROS) channel of each module via the execution engine. The execution engine of the robot 420 may transmit a command to drive the module together with a set driving option to each module with reference to time values (the startAt and the duration) of the module included in the target operation. A detailed method for the robot 420 to apply the target operation to the at least one module will be described later with reference to FIG. 10 below.

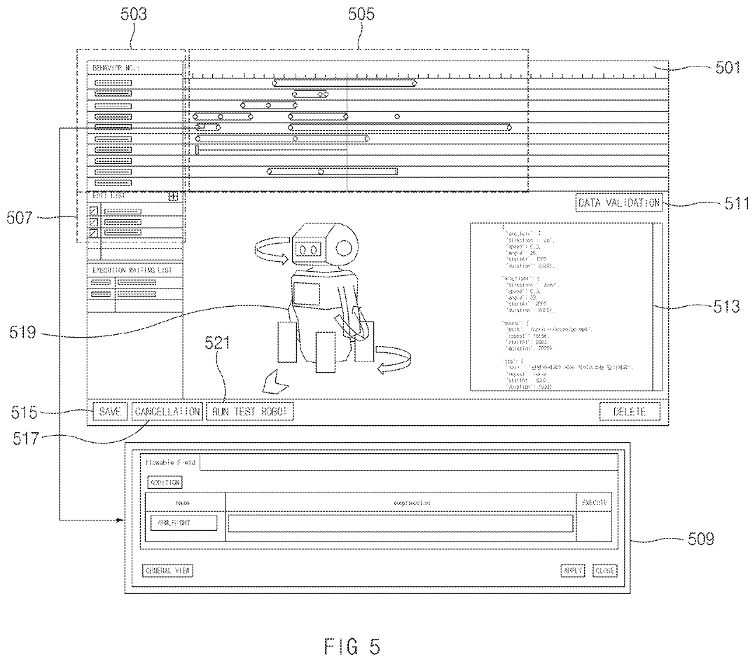

FIG. 5 is a diagram showing a screen provided to a user in a robot operation management device according to an embodiment of the present disclosure.

A robot operation management device (e.g., the robot operation management device 100 in FIG. 1) may provide a screen 501 to a user or a developer via an output device (e.g., the output device 140 in FIG. 1). In addition, the robot operation management device may obtain content of modification of a target operation applied to a robot as user data via an input device (e.g., the input device 130 in FIG. 1) by the user or the developer. The robot operation management device may generate or modify the target operation based on the obtained user data. Therefore, a role of a plurality of graphic objects contained in the screen 501 provided to the user or the developer to obtain the user data will be described in detail below.

A graphic object 503 may represent an object related to the target operation among a plurality of operations classified based on driving of at least one module included in the robot. For example, the target operation may include modules of the robot for which driving times and driving options are set. That is, the target operation may contain information in which the module of the robot and driving-related information (e.g., the driving time and the driving option) are paired with each other.

A graphic object 505 may represent an object related to a driving time of at least one module included in the target operation among the plurality of operations classified based on the driving of the at least one module included in the robot. For example, the robot operation management device may set the driving time for the at least one of the modules included in the robot as a timeline based on an input of the user. The robot operation management device may provide the driving time for which the timeline is set to the user or the developer via the screen 501 for each module.

A graphic object 507 may represent an object related to an operation list containing the target operation. For example, the robot operation management device may store the target operation as a behavior no. 1 in the operation list as shown in FIG. 5. In addition, the robot operation management device may store operations (e.g., a behavior no. 2 and a behavior no. 3) different from the target operation (i.e., the behavior no. 1) in the operation list. Based on a case where the operation different from the target operation is added to the operation list containing the target operation, the robot operation management device may set a driving time of at least one module included in the different operation and set a driving option of the at least one module included in the different operation. In addition, the robot operation management device may provide information on operations respectively corresponding to a plurality of execution commands via an execution waiting list based on a case where there are the plurality of execution commands for applying the operation different from the target operation to the robot.

A graphic object 509 may represent an object related to a driving option of the at least one module for which the driving time is set. For example, as shown in FIG. 5, a driving option of the right arm module (ARM_RIGHT) among the modules mounted on the robot may include an option of {“angle”: 30, “velocity”: 2.4, “direction”: up}.

A graphic object 511 may represent an object related to obtaining raw data of the target operation based on a first input of the user. The robot operation management device may output the raw data of the target operation as a graphic object 513 based on a user's input to the graphic object 511 as the first input. The contents of graphic object 513, which are illegible in FIG. 5, can represent raw data that indicates items such as direction, speed, angle, starting position, and duration for the arms as well as data related to sound and text, as examples. One specific example is described with respect to FIG. 6.

The graphic object 513 may represent an object related to the raw data of the target operation. The raw data may represent source code of the information in which the module of the robot and the driving-related information (e.g., the driving time and the driving option) are paired with each other. Based on a case where at least one of a first element related to the driving time or a second element related to the driving options contained in the raw data or any combination thereof is modified, the robot operation management device may reflect the content of the modification (e.g., the modification of at least one of the first element or the second element) to the target operation. That is, when the user modifies the target operation, the robot operation management device may modify the raw data of the target operation. On the other hand, when the user modifies the raw data of the target operation, the robot operation management device may modify the target operation corresponding to the modified raw data.

A graphic object 515 may represent an object related to storing the target operation based on a second input of the user. For example, the robot operation management device may verify whether the raw data of the target operation meets a data standard based on reception of the second input from the user and transmit the target operation to a control server when the raw data meets the data standard, thereby storing the raw data of the target operation as well as the target operation in the control server. For reference, the robot operation management device may provide a predetermined alarm to the user via the screen 501 based on a case where the raw data does not meet the data standard.

A graphic object 517 may represent an object related to replacing the target operation with an alternative operation based on a third input of the user. Based on the third input of the user, the robot operation management device may receive the alternative operation that corresponds to the target operation among operations stored in the control server and is stored at a time point closest to a time point at which the third input is received from the control server via a communication device, and the robot operation management device may replace the target operation with the alternative operation.

A graphic object 519 may represent a graphic object corresponding to the robot to which the target operation is applied. That is, the robot operation management device may provide a verification process of the target operation to the user via the screen 501 via simulation of the graphic object 519 corresponding to the robot.

A graphic object 521 may represent an object related to transmitting the execution command based on a fourth input of the user. For example, based on the fourth input of the user, the robot operation management device may transmit the execution command to the control server such that the target operation transmitted to the control server is applied to the robot.

By providing the screen 501 to the user, the robot operation management device may modify the target operation in a relatively short time with an intuitive user interface (UI) configuration and may provide consistent development quality to the user. In addition, by providing the screen 501 to the user, the robot operation management device may provide a function of virtual identification without a danger of accident that occurs during a robot-associated test with provision of virtual simulation. Furthermore, the robot operation management device may provide the screen 501 on which intuitive modification by a third party is possible even when the third party is not the developer in charge of the robot. In addition, the robot operation management device may quickly reflect the modified target operation to the robot without a need to perform a firmware update or distribution with only the modification of the target operation.

FIG. 6 is a diagram illustrating an example of raw data of a target operation in a robot operation management device according to an embodiment of the present disclosure.

A robot operation management device (e.g., the robot operation management device 100 in FIG. 1) may use a JavaScript Object Notation (JSON) data set in units of at least one module included in a robot as raw data 600 of a target operation.

For example, as shown in FIG. 6, the raw data 600 may store a driving time and a driving option of each of a left arm module, a right arm module, a sound module, and a text to speech module in the JSON data type. As an example, the driving option may include a control direction option (e.g., up or down), a velocity option (e.g., 0.1 m/s), an angle option (e.g., 30 degrees), a start time point (startAt) option, a duration option (i.e., capable of indicating the driving time of the corresponding module), a repeat option, a storage path option, and a text option. In particular, in relation to a start time point, the start time point may indicate a start time point at which a corresponding module of a starting point performs an operation in the target operation. That is, the start time point may represent a relative start time point at which the corresponding module relatively performs the operation in comparison to a start time point of the entire target operation. Accordingly, the robot (e.g., the robot 320 in FIG. 3) may apply the target operation to each module asynchronously from the start time point of the entire target operation based on a specified start point of each module.

FIG. 7 is a flowchart illustrating a method for a control server to perform safety validation for a module of a robot in a robot operation management system according to an embodiment of the present disclosure.

In S701, a control server (e.g., the control server 310 in FIG. 3) may receive a target operation from a robot operation management device (e.g., the robot operation management device 300 in FIG. 3).

In S703, the control server may determine whether the received target operation uses a drive system including a servo motor related to driving of at least one module. The control server may store the target operation in storage based on a case where the received target operation does not use the drive system.

In S705, the control server may obtain a threshold value related to safety validation based on a case where the received target operation uses the drive system and perform the safety validation via comparison of the obtained threshold value with a driving option included in the received target operation. Based on a case where the received target operation is applied to at least one module included in a robot, the safety validation may include at least one of validation of a position of the module, validation of a velocity of the module, validation of a torque of the module, or validation of an acceleration of the module, or any combination thereof.

In S707 to S713, the control server may execute validation on whether each of driving options included in the target operation is within a preset safety specification range (i.e., the obtained threshold value). For reference, the control server may obtain threshold values for respective modules of each driving option included in the target operation. For example, when the servo motor corresponding to a right arm module has a driving range from 30 to 300 degrees to prevent a physical collision with an outer appearance of the robot, the control server may obtain a threshold value in a range from 30 to 300 degrees for the right arm module.

In S715, the control server may process that the safety validation has failed based on a case where at least one of the driving options included in the received target operation is greater than the obtained threshold value. In addition, the control server may transmit an alarm provision command to the robot operation management device such that the robot operation management device provides a predetermined alarm to a user.

In S717, based on a case where the safety validation for the at least one module mounted on the robot is passed, the target operation may be stored in the storage of the control server.

FIG. 8 is a flowchart illustrating a method for a control server to process an execution command in a robot operation management system according to an embodiment of the present disclosure.

In S810, a control server (e.g., the control server 310 in FIG. 3) may receive a target operation from a robot operation management device (e.g., the robot operation management device 300 in FIG. 3).

In S820, the control server may determine whether an operation related to a preceding execution command is being applied to a robot (e.g., the robot 320 in FIG. 3). For example, the control server may insert an execution command into a waiting queue in S830 based on a case where the operation related to the preceding execution command preceding the execution command is being applied to the robot. A detailed description of the waiting queue will be described later in FIG. 9 below.

In S840, the control server may process the execution command related to the target operation based on a case where the operation related to the preceding execution command is not being applied to the robot. Specifically, in S850, the control server may process a first inserted execution command among the execution commands inserted into the waiting queue based on a case where the preceding execution command is ended. Next, the control server may process the execution command related to the target operation when there is no execution command inserted into the waiting queue. In particular, the control server may process the execution command related to the target operation based on a case where the robot is in an execution standby state because there is no execution command to be applied to the robot.

FIG. 9 is a diagram illustrating a method for a control server to insert an execution command into a waiting queue in a robot operation management system according to an embodiment of the present disclosure.

A control server (e.g., the control server 310 in FIG. 3) may process an execution command with reference to a waiting queue 900 based on reception of the execution command for applying a target operation to a robot (e.g., the robot 320 in FIG. 3). For example, the waiting queue 900 is for solving a concurrency problem when execution commands are transmitted from multiple users and is able to represent a queue adopting a first in first out (FIFO) scheduling scheme.

For example, because there is no command being executed in the robot at a time point at which the control server receives a command ‘A’ 910, the control server may immediately execute the command ‘A’ 910. At time points at which the control server receives a command ‘B’ 920 and a command ‘C’ 930, because the command ‘A’ 910 is being executed by the robot, the control server may insert the command ‘B’ 920 and the command ‘C’ 930 into the waiting queue 900.

The control server may execute the command ‘B’ 920, which is the oldest command inserted among commands waiting in the waiting queue 900, after the execution of the command ‘A’ 910 in the robot is ended. In addition, the control server may execute the command ‘C’ 930, which is the oldest command inserted among the commands waiting in the waiting queue 900, after the execution of the command ‘B’ 920 in the robot is ended. In addition, because there is no command being executed in the robot at a time point at which the control server receives a command ‘D’ 940, the control server may immediately execute the command ‘D’ 940.

FIG. 10 is a flowchart illustrating a method for a robot to apply a target operation to a module in a robot operation management system according to an embodiment of the present disclosure.

In S1001, a robot (e.g., the robot 320 in FIG. 3) may receive a target operation from a control server (e.g., the control server 310 in FIG. 3). For example, the robot may receive the target operation related to an execution command along with the execution command from the control server.

In S1003 and S1005, the robot may obtain information related to the module after interpreting the target operation or the execution command. For example, the robot may obtain information related to at least one module included in the target operation based on the target operation related to the execution command and perform an inspection on whether the at least one module is a module mounted on the robot.

In S1007 and S1009, the robot may set a second time point subsequent to a first time point of obtaining the information related to the at least one module included in the target operation based on a case where the at least one module included in the target operation is the module mounted on the robot and transmit a standby command for setting the at least one module to be in a standby mode from the first time point to the second time point to the at least one module.

In S1011, the robot may apply the target operation to the at least one module from the second time point. That is, from the second time point, the robot may perform the target operation via driving of the module by applying the target operation to the at least one module mounted on the robot.

In S1013, the robot may set a third time point that is different from the first time point and the second time point and indicates an end time point of the target operation and determine whether a time for applying the target operation is subsequent to the third time point. In this regard, the robot may end the target operation applied to the at least one module when the time for applying the target operation is subsequent to the third time point.

In S1015, the robot may determine whether a state of the robot is an end state and end the target operation applied to the at least one module. For example, the robot may obtain the state of the robot applying the target operation based on a predetermined clock from the second time point. When the state of the robot is not the end state, the robot may determine whether the third time point has passed every predetermined clock. In this regard, when the state of the robot is not the end state and the time for applying the target operation is subsequent to the third time point, the robot may end the target operation applied to the at least one module. In contrast, when the state of the robot is the end state, the robot may immediately end the target operation applied to the at least one module without determining whether the time for applying the target operation is subsequent to the third time point.

In summary, the robot may end the target operation applied to the at least one module based on at least one of whether the state of the robot is the end state or whether a time point at which the state of the robot is obtained is subsequent to the third time point or any combination thereof.

FIG. 11 is a diagram illustrating operations stored in storage of a control server in a robot operation management system according to an embodiment of the present disclosure.

A control server (e.g., the control server 310 in FIG. 3) may store a plurality of operations in storage, like a list 1110. For example, the list 1110 may contain the plurality of operations, and each of the plurality of operations that may be distinguished from each other by IDs may include Name, Config, Error Status, User, Create Date, and Modify Date. The Name may indicate names of the operations. Herein, for convenience of description, a description will be mainly made with a behavior no. 1 as a target operation. The Config may indicate content of raw data (e.g., JSON text content) of the target operation. For reference, the Config is described as indicating the JSON text content, but may not be limited thereto, and may indicate extensible markup language (XML) text or comma-separated values (CSV) text content. The Error Status may indicate content of an error that has occurred when each of the plurality of operations that may be distinguished from each other by the IDs is stored in the storage. The User may indicate information on a user who has modified the operation for each of the plurality of operations that may be distinguished from each other by the IDs. The Create Date and the Modify Date may respectively indicate an initial creation date and a modification date for each of the plurality of operations that may be distinguished from each other by the IDs.

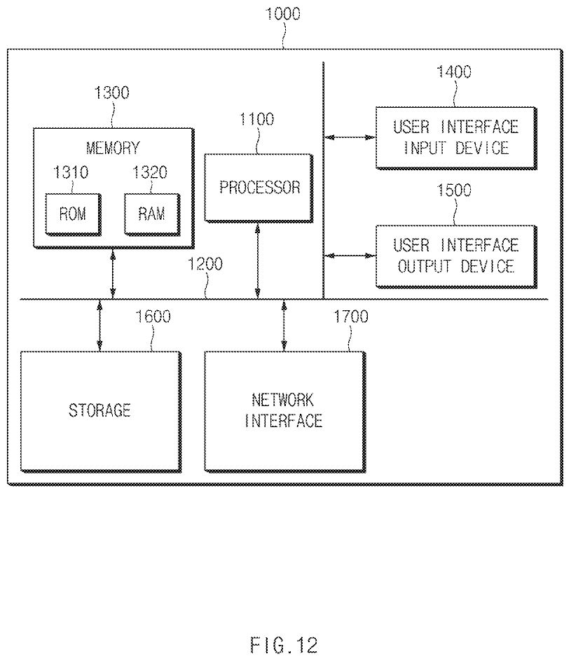

FIG. 12 is a diagram illustrating a computing system related to a robot, a robot operation management device, a system including the same, and a robot operation management method according to an embodiment of the present disclosure.

With reference to FIG. 12, a computing system 1000 related to a robot, a robot operation management device, a system including the same, and a robot operation management method may include at least one processor 1100, a memory 1300, a user interface input device 1400, a user interface output device 1500, a storage (i.e., a memory) 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100 or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium is coupled to the processor 1100, which may read information from and write information to the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of embodiments of the present disclosure, and various modifications and changes may be made by those skilled in the art without departing from the essential characteristics of the embodiments of the present disclosure.

The embodiments described above may be realized with hardware components, software components, and/or combinations of the hardware components and the software components. For example, the device, the method, and the components described in the embodiments may be, for example, realized using a general purpose computer or a special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device may execute an operating system (OS) and a software application running on the operating system. The processing device may also access, store, manipulate, process, and generate data in response to the execution of the software. For convenience of understanding, there is a case where a description is made with one processing device used, but a person skilled in the art will appreciate that the processing device may include a plurality of processing elements and/or a plurality of types of processing elements. For example, the processing device may include a plurality of processors or one processor and one controller. In addition, the processing device may include other processing configurations, such as parallel processors.

The software may include a computer program, codes, instructions, or combinations of one or more of those and may configure the processing device to operate as desired or may command the processing device independently or collectively. The software and/or data may be permanently or temporarily embodied on any type of machine, component, physical device, virtual equipment, computer storage medium or device, or transmitted signal wave to be interpreted by or to provide the instructions or the data to the processing device. The software may be distributed on networked computer systems and stored or executed in the distributed manner. The software and the data may be stored on a computer readable medium.

The method according to the embodiments may be implemented in a form of program instructions that may be executed via various computer means and recorded on the computer readable medium. The computer readable medium may include a program instruction, a data file, a data structure, and the like alone or in combination. The program instruction recorded on the medium may be specially designed and configured for the embodiment or may be known and usable to those skilled in computer software. Examples of the computer readable recording media include magnetic media such as a hard disk, a floppy disk, and a magnetic tape, optical media such as a CD-ROM and a DVD, magneto-optical media such as a floptical disk, and hardware devices specially configured to store and execute the program instructions such as a ROM, a RAM, and a flash memory. Examples of the program instructions include high-level language codes that may be executed by the computer using an interpreter or the like, as well as machine language codes such as those produced by a compiler.

The hardware device described above may be configured to operate with one or a plurality of software modules to perform the operation of the embodiments and vice versa.

As described above, although the embodiments have been described with limited drawings, those skilled in the art may apply various technical modifications and variations based on them. For example, even when the described techniques are performed in an order different from that in the method described, and/or the components of the described system, structure, device, circuit, and the like are coupled or combined with each other in a form different from that in the method described, or other components are replaced with or substituted by equivalents, appropriate results may be achieved.

Therefore, other implementations, other embodiments, and equivalents of the claims are within the scope of the following claims.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

Effects of the robot, the device for managing the operation of the robot, the system including the same, and the method for managing the operation of the robot according to embodiments of the present disclosure will be described as follows.

According to at least one of the embodiments of the present disclosure, as the target operation related to the operation of the robot is generated and modified, the operation of the robot may be controlled based on units of the operation for each module mounted on the robot instead of being controlled in units of the source code, and the convenience and the efficiency may be provided to the developer or the user in the process of controlling the operation of the robot.

In addition, according to at least one of the embodiments of the present disclosure, as the target operation is verified for the graphic object corresponding to the robot, the need for the test robot may be minimized and the development cost of the robot may be reduced, the safety of the test robot may be guaranteed against the concurrent execution of the plurality of developers or users, and the usability may be provided to the developers or the users.

In addition, according to at least one of the embodiments of the present disclosure, as the safety validation on the module mounted on the robot is performed, the stability of the test robot as well as the rapidity of reflecting the modification request of the user to the robot in real time via the association of the engine that interprets the operation data and the operation rather than the code reflected to the robot after the building of the source code may be guaranteed.

In addition, various effects identified directly or indirectly through the present document may be provided.

Hereinabove, although embodiments of the present disclosure have been described with reference to exemplary embodiments and the accompanying drawings, the embodiments of the present disclosure are not limited thereto, but they may be variously modified and altered by those skilled in the art to which the present disclosure pertains without departing from the spirit and scope of the present disclosure claimed in the following claims.

What is claimed is:

1. A device for managing an operation of a robot, the device comprising:
a memory configured to store computer-executable instructions;
a communication device configured to be in communication with a control server; and
at least one processor configured to access the memory and execute the instructions, to cause the at least one processor to:
set a driving time of at least one module included in a target operation among a plurality of operations classified based on driving of at least one module included in the robot;
set a driving option of the at least one module whose driving time is set;
verify the target operation via simulation of a graphic object corresponding to the robot; and
transmit the verified target operation to the control server via the communication device such that the verified target operation is applied to the robot.

2. The device of claim 1, wherein the at least one processor is configured to:
set, based on a case where a different operation from the target operation is added to an operation list containing the target operation, a driving time of at least one module included in the different operation; and
set a driving option of the at least one module included in the different operation.

3. The device of claim 1, wherein the at least one processor is configured to provide, based on a case where there are a plurality of execution commands for applying a different operation from the target operation to the robot, information on an operation corresponding to each of the plurality of execution commands.

4. The device of claim 1, wherein the at least one processor is configured to:
obtain raw data of the target operation based on a first input of a user; and
reflect, based on a case where a first element related to the driving time or a second element related to the driving option contained in the raw data is modified, the modification to the target operation.

5. The device of claim 1, wherein the at least one processor is configured to:
verify whether raw data of the target operation meets a data standard based on a second input of a user;
transmit the target operation to the control server via the communication device based on a case where the raw data meets the data standard; and
provide a predetermined alarm to the user based on a case where the raw data does not meet the data standard.

6. The device of claim 1, wherein the at least one processor is configured to:
receive, based on a third input of a user, an alternative operation corresponding to the target operation and stored at a time point closest to a time point when the third input is received among operations stored in the control server from the control server via the communication device; and
replace the target operation with the alternative operation.

7. The device of claim 1, wherein the at least one processor is configured to transmit an execution command to the control server such that the target operation transmitted to the control server is applied to the robot based on a fourth input of a user.

8. A system for managing an operation of a robot, the system comprising:
a robot operation management device;
a control server; and
the robot configured to receive a command from the control server;
wherein the robot operation management device is configured to:
set a driving time of at least one module included in a target operation among a plurality of operations classified based on driving of at least one module included in the robot;
set a driving option of the at least one module whose driving time is set;
verify the target operation via simulation of a graphic object corresponding to the robot; and
transmit the verified target operation to the control server such that the verified target operation is applied to the robot; and
wherein the control server is configured to transmit an execution command to the robot based on the verified target operation received from the robot operation management device.

9. The system of claim 8, wherein:
the control server is configured to:
perform safety validation for the at least one module mounted on the robot based on the reception of the verified target operation from the robot operation management device; and
process the execution command by referring to a waiting queue based on reception of the execution command for applying the target operation to the robot; and
wherein the robot is configured to apply the target operation to the at least one module in response to the processed execution command.

10. The system of claim 9, wherein, based on a case where the received target operation is applied to the at least one module included in the robot, the safety validation comprises validation of a position of the module, validation of a velocity of the module, validation of a torque of the module, or validation of an acceleration of the module.

11. The system of claim 9, wherein the control server is configured to:
determine whether the received target operation uses a drive system including a servo motor related to the driving of the at least one module;
obtain a threshold value related to the safety validation based on a case where the received target operation uses the drive system; and
perform the safety validation by comparing the obtained threshold value with the driving option included in the received target operation.

12. The system of claim 11, wherein the control server is configured to transmit an alarm provision command to the robot operation management device such that the robot operation management device provides a predetermined alarm to a user based on a case where at least one of the driving options included in the received target operation is greater than the obtained threshold value.

13. The system of claim 9, wherein the control server is configured to store the target operation in storage of the control server based on a case where the safety validation for the at least one module mounted on the robot is passed.

14. The system of claim 9, wherein the control server is configured to:
insert the execution command into the waiting queue based on a case where an operation of a preceding execution command preceding the execution command is being applied to the robot; and
process the execution command inserted first among a plurality of the execution commands inserted into the waiting queue based on a case where the preceding execution command is ended.

15. The system of claim 9, wherein the control server is configured to process the execution command based on a case where the robot is in an execution standby state.

16. A robot, wherein the robot is configured to:
obtain information on at least one module included in a target operation related to an execution command received from a control server; and
perform an inspection on whether the at least one module is a module mounted on the robot.

17. The robot of claim 16, wherein the robot is configured to:
set a second time point subsequent to a first time point for obtaining the information on the at least one module included in the target operation based on a case where the at least one module included in the target operation is the module mounted on the robot;
transmit a standby command for setting the at least one module to be in a standby mode from the first time point to the second time point to the at least one module; and
apply the target operation to the at least one module from the second time point.

18. The robot of claim 17, wherein the robot is configured to:
set a third time point different from the first time point and the second time point and indicating an end time point of the target operation;
obtain a state of the robot applying the target operation based on a predetermined clock from the second time point; and
end the target operation applied to the at least one module based on whether the state of the robot is an end state or whether a time point for obtaining the state of the robot is subsequent to the third time point.

19. A method for managing an operation of a robot, the method comprising:
setting, by a robot operation management device, a driving time of at least one module included in a target operation among a plurality of operations classified based on driving of at least one module included in the robot;
setting, by the robot operation management device, a driving option of the at least one module whose driving time is set;
verifying, by the robot operation management device, the target operation via simulation of a graphic object corresponding to the robot;
transmitting, by the robot operation management device, the verified target operation to a control server such that the verified target operation is applied to the robot; and
transmitting, by the control server, an execution command to the robot based on the verified target operation received from the robot operation management device.

20. The method of claim 19, further comprising:
performing, by the control server, safety validation for the at least one module mounted on the robot based on the reception of the verified target operation from the robot operation management device;
processing, by the control server, the execution command by referring to a waiting queue based on reception of the execution command for applying the target operation to the robot; and
applying, by the robot, the target operation to the at least one module in response to the processed execution command.
